(19) United States
(12) Patent Application Publication
(10) Pub. No.: US 2007/0053365 A1
(43) Pub. Date: Mar. 8, 2007

(54) One digital network control system

(76) Inventor: Yongho Choi, Torrance, CA (US)

Correspondence Address: PARK LAW FIRM, 3255 WILSHIRE BLVD, SUITE 1110, LOS ANGELES, CA, 90010, US

(21) Appl. No.: 11/219,196

(22) Filed: Sep. 2, 2005

(51) Int. Cl. H04L 12/56

(52) U.S. Cl. 370/400

(57) ABSTRACT

A digital network system includes a user communication interface that is adapted to be connected to a public communication network that transfers information between the digital network system and a communication device, a control communication interface that is adapted to exchange information between the digital network system and an electronic device that a user wants to control, a device control module that is adapted to control the electronic device, and includes a device control software, a network connection module that includes a communication software, a signal generating device, and a signal recognizing device. The communication software is adapted to be connected to a home page of the electronic device through the internet. The system is adapted to be embedded in the electronic device.

### BACKGROUND OF THE INVENTION

The present invention relates to an integrated remote control system for electronic appliances over PSTN and the Internet. More particularly, the invention relates to an integrated remote control system, or one digital network control system that maximizes utilization of popular features of electronic appliances such as infrared light remote control and popular communication devices such as a cell phone or a computer connected to the Internet. Also, the invention relates to a unified integrated digital control system that are based on wire and wireless communication network, wire and wireless Internet and equipped with wire or wireless phones and wire or wireless personal computers.

Today, there are many communication and control systems that serve the needs of various aspects of human life. Such communication systems include PSTN (public switched telephone network) and the Internet. There are many short-distance control schemes that utilize infrared light, voice, microwave, etc., and used mainly for controlling electronic appliances.

While such devices and systems have been effective in serving the particular needs for which they were developed, they have increased complexity of manufacturing and training required to use them.

For a long time, there has been a need to provide a system and method that can utilize existing communication methods and systems in order to control various electric and electronic facilities without adding complexity to existing control schemes and with minimal hardware cost.

### SUMMARY OF THE INVENTION

The present invention contrives to solve the disadvantages of the prior art.

An objective of the invention is to provide one digital network control system that use wire or wireless communication in order to control appliances or machines remotely.

Another objective of the invention is to provide one digital network control system having a user-friendly interface.

Still another objective of the invention is to provide one digital network control system that can be constructed with popular and cheap hardware.

In order to achieve the above-objectives, the present invention provides a digital network system that includes a user communication interface that is adapted to be connected to a public communication network that transfers information between the digital network system and a communication device, a control communication interface that is adapted to exchange information between the digital network system and an electronic device that a user wants to control, a device control module that is adapted to control the electronic device and includes a device control software, and a network connection module that includes a communication software.

The public communication network includes the Internet, the public switched telephone network and the mobile communication network.

The communication device includes a wire telephone, a wireless telephone, a cell phone and a personal computer.

The communication software is adapted to be connected to a home page of the electronic device through the internet.

The home page displays control functions for the electronic device. The user selects a control function in order to control the electronic device. The home page converts the control function into a number code, and sends the number code to the user communication interface.

The number code includes three to five digits. The home page displays a plurality of screen switches. Each of the screen switches includes one of the number codes.

One half of the home page displays the screen switches in a grid, and the other half of the home page displays control functions.

The device control module and the network control module communicates with each other according to the number code sent by the home page.

The digital network control system further includes a signal generating device and a signal recognizing device.

The signal is in the form of sound wave or light. The signal generating device generates a predetermined pattern of sound wave or light according to the number code, and the signal recognizing device recognizes the predetermined pattern.

The device control software of the device control module operates to send commands to the electronic device.

The digital network control system is adapted to be embedded in the electronic device.

The control communication interface includes a infrared ray transmitter. The infrared ray transmitter is operated when the user communication interface receives a command from a user and sends signals to the infrared ray transmitter.

The user communication interface includes a wireless LAN and a wireless modem.

The digital network control system is operated when a proper user is authenticated through the public communication network. A user may be authenticated through the call transfer connection service of the public switched telephone network.

The authentication is performed with checking a predetermined telephone number.

A user selects a command with a selection system using a telephone. The selection system uses voice or number to recognize input of the user.

The selection system provides prerecorded voice menu to the user. The user follows the voice menu to select a desired control function of the electronic device.

The user communication interface includes a telephone receiver. The telephone receiver receives the control function.

The telephone receiver recognizes the control function according to predetermined telephone number. The control communication interface includes a infrared ray transmitter. The infrared ray transmitter is operated when the telephone receiver receives the control function, and sends signals to the infrared ray transmitter according to the control function.

The digital network control system may communicate with another digital network control system to control an electronic device.

The digital network control system may be integrated with the other digital network control system, and the two integrated digital network control system functions as a single digital network control system.

The advantages of the present invention are as follows:

(1) The one digital network control system eliminates unnecessary electric energy waste since the system can turn the power on and off remotely anywhere wire or wireless communication is available. The one digital network control system can be operated with the power supply of a rechargeable battery that is used in a wireless phone, or tiny amount of electric power at the voltage of about 3 V. The one digital network control system can control all electric or electronic appliances, main computer devices that control the entire factory facilities, and large scale machineries that are used in various industries, which can be reachable through wire or wireless communication. The one digital network control system can control the huge amount of electric energy conveniently at necessity. Thus, the one digital network control system of the present invention contributes to solve the energy crisis of the mankind.

(2) The one digital network control system can turn on and off, and remotely control an electronic appliance that is located that a user wants from any location at which wire or wireless communication is available. Also maintenance check and program recovery is possible depending on level of control software.

(3) The one digital network control system enables easy control of an individual's electronic appliances from a remote place, and utilizes existing, widely dispersed internet networking system and various wire or wireless communication facilities. Therefore, the one digital network control system can give benefits to many people in a short time.

(4) The one digital network control system maximizes utilization of existing technical devices and existing control system for the devices.

(5) The one digital network control system minimizes knowledge and study required for a new user to understand how to use the new system since it is provides as a simple add-on device to existing facilities that are familiar to the user.

(6) The one digital network control system can be manufactured at a minimal cost since it is compatible with existing control systems and methods.

(7) The one digital network control system does not require alteration of existing communication network since it is compatible with current communication devices and methods.

(8) The one digital network control system can be embedded in existing devices or provided as simple and cheap add-on devices.

(9) The one digital network control system provides a unified and integrated control device and method that covers all existing electric or electronic devices that are remotely controlled.

(10) The one digital network control system provides synergy to both manufacturers of existing electronic appliances and communication service provides of the internet, and wire/wireless telephones. Business using the one digital network control system can be readily started with existing technologies.

(11) The one digital network control system provides an integrated solution eliminating time and money waste in electronic appliance use by mankind, and providing spatial freedom.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing one digital network control system according to the first embodiment of the present invention;

FIG. 2 is a flow diagram showing the operation of the one digital network control system of FIG. 1;

FIG. 3 is a schematic diagram showing one digital network control system according to the second embodiment of the present invention;

FIG. 4 is a flow diagram showing the operation of the one digital network control system of FIG. 3;

FIG. 5 is a schematic diagram showing an application example of the one digital network control system;

FIG. 6 is a schematic view showing how an appliance is controlled remotely with the one digital network control system of the present invention;

FIG. 7 is a schematic diagram showing a home page of an electronic device;

FIG. 8 is a schematic diagram showing one digital network control system cooperating with another digital control system; and

FIG. 9 is a schematic diagram showing two digital network control system are integrated and functions as one digital network control system.

### DETAILED DESCRIPTION OF THE INVENTION

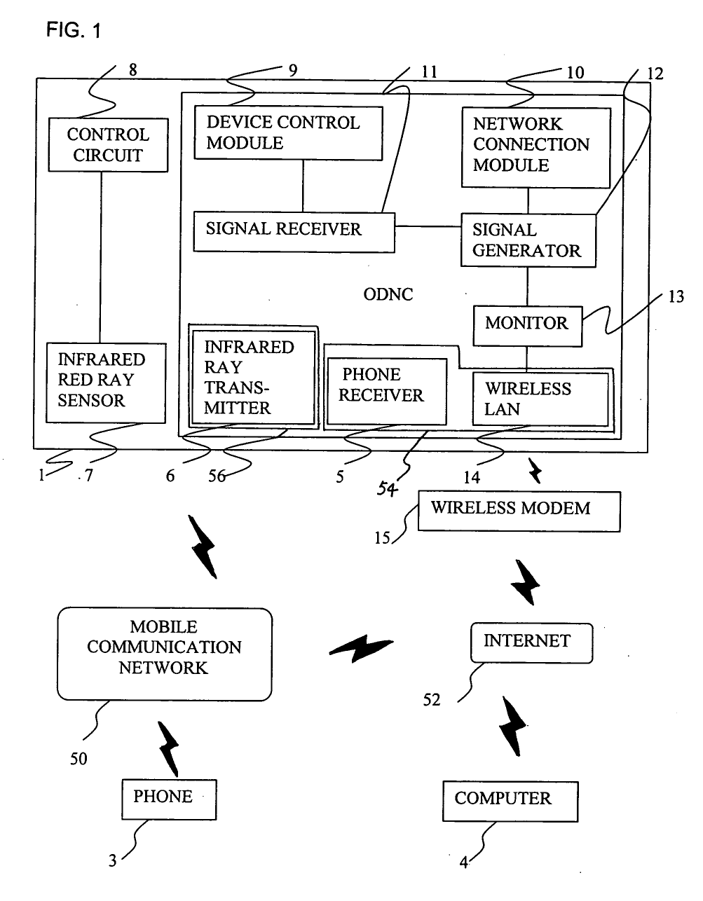

FIG. 1 shows an electronic device 1, which is connected with a mobile communication network 50 and the internet 52, and a digital network system or one digital network control system (ODNC hereinafter) 2 embedded in the electronic device 1 according to the first embodiment of the present invention. FIG. 1 also shows a wireless phone 3 and a wireless computer 4. The electronic device 1 includes an infrared ray sensor 7, and a control circuit 8 for controlling the electronic device 1.

The ODNC 2 includes a user communication interface 54 that is adapted to be connected to a public communication network that transfers information between the digital network system 2 and a communication device, a control communication interface 56 that is adapted to exchange information between the digital network system 2 and the electronic device 1 that a user wants to control, a device control module 9 that is adapted to control the electronic device 1 and includes a device control software, and a network connection module 10 that includes a communication software, and a monitor 13. The device control software has roles of controlling the electronic device 1 and recognizing sound or light signals. The communication software has roles of internet connection, and generating sound or light signals.

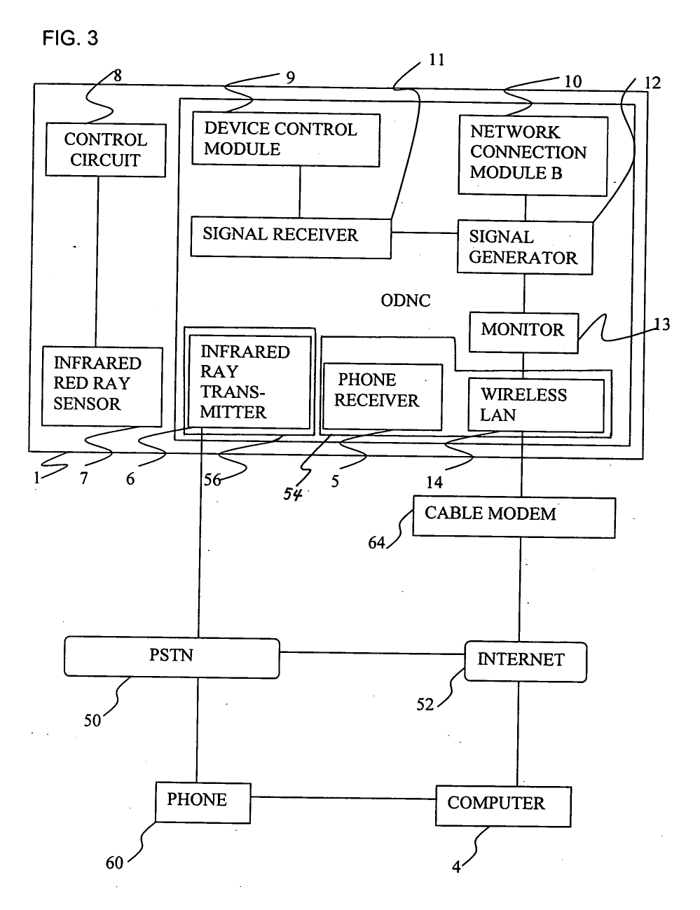

The public communication network may include the Internet 52, the public switched telephone network 58 (refer to FIG. 3) or the mobile communication network 50.

The communication device may include a wire telephone 60 (refer to FIG. 3), a wireless telephone, a cell phone 3 and a personal computer 4.

The ODNC 2 is adapted to be embedded in or connected to the electronic device 1. The electronic device 1 can be any device that has a control software. The infrared ray sensor 7 may be provided in the ODNC 2 together with an infrared ray transmitter 6.

The control communication interface 56 includes the infrared ray transmitter 6. The user communication interface 54 includes a wireless LAN 14, a wireless modem 15 and a phone receiver 5. The phone receiver 5 can receive wire or wireless phone signal. The infrared ray transmitter 6 is connected to the phone receiver 5, and operated when the user communication interface 56 receives a command from a user and sends signals to the infrared ray transmitter 6.

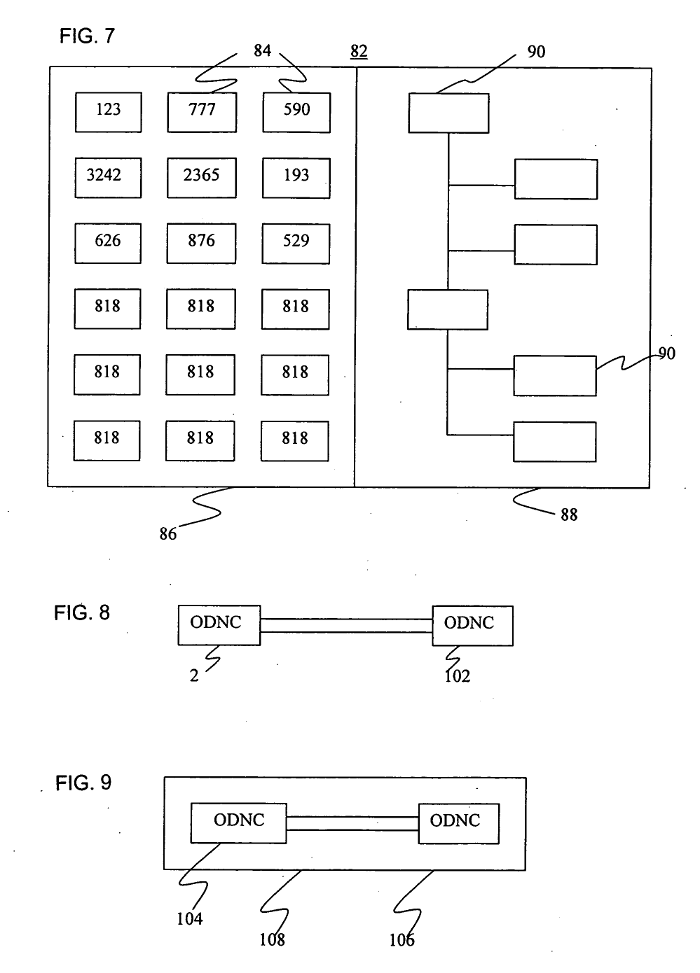

The communication software is adapted to be connected to a home page 82 (refer to FIG. 7) of the electronic device 1 through the internet 52.

The home page 82 displays control functions 90 for the electronic device 1. The user selects a control function in order to control the electronic device 1. The home page converts the control function into a number code, and sends the number code to the user communication interface 54.

The number code includes three to five digits. The home page displays a plurality of screen switches 84. Each of the screen switches includes one of the number codes.

One half 86 of the home page displays the screen switches 84 in a grid, and the other half 88 of the home page displays control functions.

The device control module 9 and the network control module 10 communicates with each other according to the number code sent by the home page 82.

The ODNC 2 further includes a signal generating device 12 and a signal recognizing device 11. A speaker may be used as the signal generating device 12.

The signal is in the form of one of sound wave and light. The signal generating device 12 generates a predetermined pattern of sound wave or light according to the number code, and the signal recognizing device 11 recognizes the predetermined pattern.

The device control software of the device control module 9 operates to send commands to the electronic device 1.

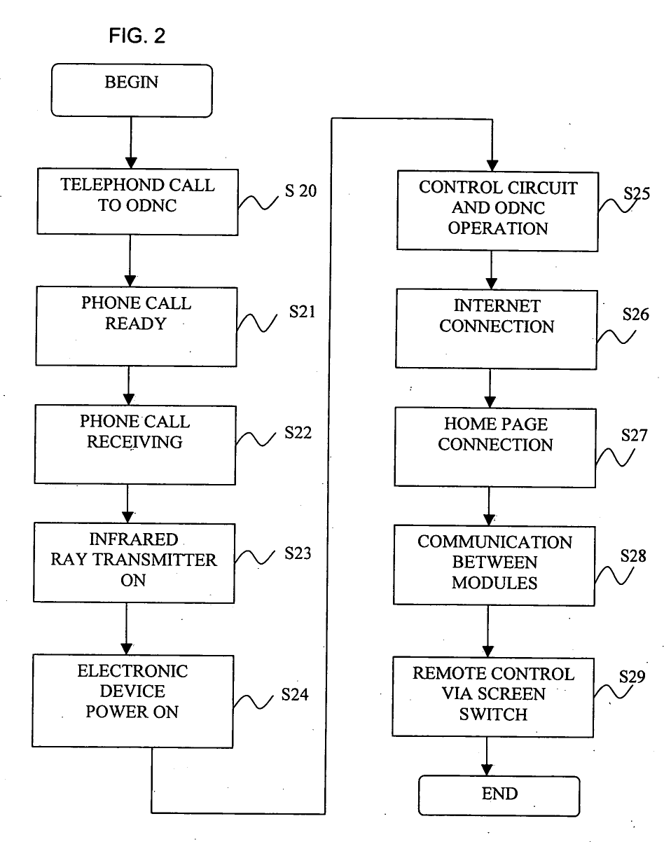

Referring FIG. 2, the operation of ODNC 2 is explained. In step S20, a user makes a telephone call with a wire or wireless phone. In step S21, the phone call is relayed through the mobile communication network. In step S22, the phone call is received by the phone receiver S. In step S23, the infrared ray transmitter 6 is turned on to remotely control the electronic device 1. In step S24, the infrared ray sensor 7 within the electronic device 1 receives the infrared ray signal and electric power is supplied to the electronic device 1 and the ODNC 2. In step S25, the control circuit 8 of the electronic device 1, and the ODNC 2 are operated. In step S26, the ODNC 2 is connected to the internet 52 via a wireless LAN 14, a wireless modem 15 or a cable, etc. In step S27, the home page screen of the electronic device 1 is connected by the setting of the software of the ODNC 2. One half of the home page screen 82 has the screen switches 84 arranged in a grid that resembles a chess board. The other half of the home page screen displays the various control functions 90, which are organized in a way that a user can easily find a control function that corresponds to desired operation of the electronic device 1. When a user clicks a control function 90, the corresponding number code of the screen switch 84 is pushed. In step S28, and the network connection module 10 operates to generate predetermined luminosity of light or sound wave according to the number code, and the device control module 9 operates to sense the light or sound wave and sends commands to the electronic device 1. The network control module 10 and the device control module 9 communicate with other to perform such functions. In step S29, the electronic device 1 is controlled remotely with screen switches via a wireless phone 3 or computers 4 connected to the internet.

FIG. 3 shows the second embodiment of the present invention. The electronic device 1 is connected to a wire telephone network, or the PSTN 58. FIG. 3 illustrates a wire telephone 60, and a cable modem 64.

The ODNC 2 is operated when a proper user is authenticated through the public communication network. A user may be authenticated through the call transfer connection service (number selection switch system with prerecorded voice information, automatic switch system with voice recognition) of the public switched telephone network. The call transfer connection service performs classification and choice of telephone numbers. The call transfer connection service and the automatic switch service of the PSTN are used to choose telephone numbers among a plurality of telephones and perform authentication by checking an identification number. The authentication by call transfer connection prevents unauthorized use of ODNC 2, and enables operation of the ODNC 2 even when the telephone connected to the ODNC 2 is busy.

The authentication is performed with checking a predetermined telephone number.

A user selects a command with a selection system using a telephone. The selection system uses voice or number to recognize input of the user.

The selection system provides prerecorded voice menu to the user. The user follows the voice menu to select a desired control function of the electronic device.

The user communication interface 54 includes the phone receiver 5. The phone receiver 5 receives the control function.

The phone receiver 5 recognizes the control function according to predetermined telephone number. The control communication interface 56 includes the infrared ray transmitter 6. The infrared ray transmitter 6 is operated when the telephone receiver 5 receives the control function, and sends signals to the infrared ray transmitter 6 according to the control function. The infrared ray sensor 7 of the electronic device 1 receives infrared ray signal transmitted by the infrared ray transmitter 6. In this way, any number of functions that are possible to represent with the infrared ray remote control technology may be controlled remotely with only the wire or wireless telephone and without the internet.

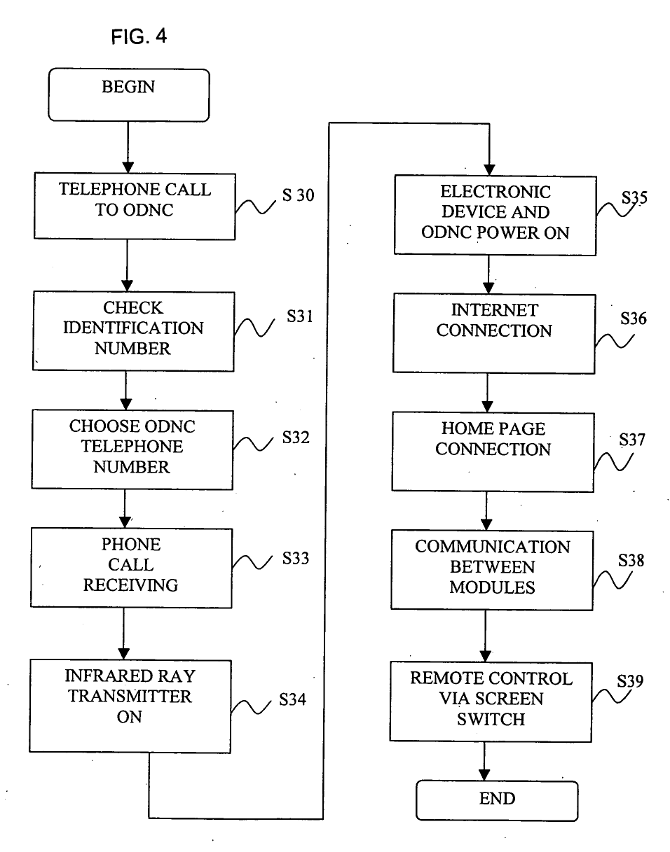

Referring FIG. 4, the operation of the ODNC 2 is explained. In step S30, a user sends a call to the ODNC 2 with a wire telephone 60. In step S31, the identification number is checked through the automatic switch service of the PSTN. In step S32, the number for the phone receiver 5 of the ODNC 2 is chosen by the call transfer connection. In step S33, the phone receiver 5 of the ODNC 2 receives the signal. In step S34, the infrared ray transmitter 6 is turned on to remotely control the electronic device 1. In step S35, the infrared ray sensor 7 within the electronic device 1 receives the infrared ray signal and electric power is supplied to the electronic device 1 and the ODNC 2. In step S36, the ODNC 2 is connected to the internet 52 via the wireless modem and the cable. In step S37, the homepage screen of the electronic device 1 is connected by the setting of the software of the network connection module 10. One half of the home page screen 82 has the screen switches 84 arranged in a grid that resembles a chess board. The other half of the home page screen displays the various control functions 90, which are organized in a way that a user can easily find a control function 90 that corresponds to desired operation of the electronic device 1. When a user clicks a control function, the corresponding number code of the screen switch 84 is pushed. In step S38, and the network connection module 10 operates to generate predetermined luminosity of light or sound wave according to the number code, and the device control module 9 operates to sense the light or sound wave and sends commands to the electronic device 1. The network control module 10 and the device control module 9 communicate with other to perform such functions. In step S39, the electronic device 1 is controlled remotely with screen switches via a wire telephone 60 or computers 4 connected to the internet.

When the communication between the device control module 9 and the network connection module 10 is performed just with sound or light signal, the monitor 13 is not necessary to be installed to the ODNC 2. The monitor 13 is installed for convenience of a user when the ODNC 2 is detachably installed to the electronic device 1. In addition, other computer functions or notebook computer functions may be provided to the ODNC 2. The ODNC 2 may include devices that enable the communication between the device control module 9 and the network connection module 10 with transfer medium other than sound and light. In order to block unauthorized use of the electronic device 1, password authentication may be provided for connecting to the home page 82 of the electronic device 1.

Operations common to the embodiments are explained. When a user makes a phone call with the wire or wireless telephone, the phone receiver 5 installed inside the ODNC 2 that is in turn embedded in the electronic device 1, receives the signal, and the infrared ray transmitter 6, which is connected to the phone receiver 5, is turned on and sends signal to the infrared ray sensor 7 that is installed inside the electronic device 1. Accordingly, electric power is supplied to the electronic device 1 and the ODNC 2, and the control circuit 8 of the electronic device 1 is operated. Also, electric power is supplied to the device control module 9, the network connection module 10, the 13, the signal receiver 11 and the signal generator 12, which are installed inside the ODNC 2. The ODNC 2 is connected to the internet via the wireless LAN 14, the wireless modem 15 and/or a cable modem. Through the use of the signal receiver 11 and the signal generator 12, the electronic device 1 can be remotely controlled from anywhere, at which the internet or wire or wireless telephone communication is available, with a computer that can be connected to the internet, or a wire or wireless phone.

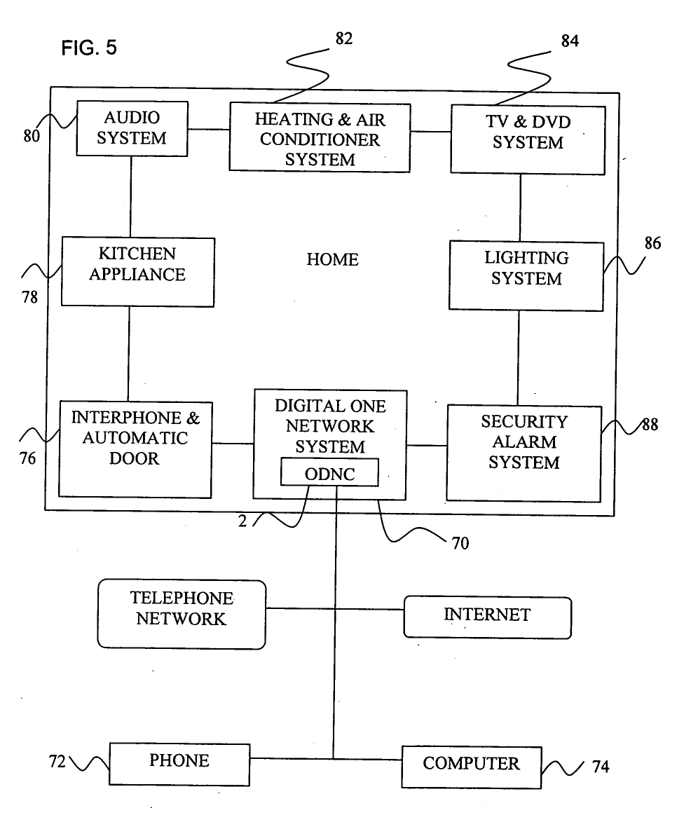

FIG. 5 shows an example in which the ODNC 2 is used to remotely control electric or electronic appliances at home. A digital one network system 70, in which the ODNC 2 is installed, covers all home appliances including an interphone & automatic door 76, a kitchen appliance 78, an audio system 80, a heating & air conditioning system 82, a TV & DVD system 84, a lighting system 86 and a security alarm system 88. The digital one network system 70 is connected to the wire/wireless telephone network and the internet. FIG. 5 also shows a wire/wireless phone 72 and a wire/wireless computer 74. With the construction of FIG. 5, all appliances at home can be freely controlled at a remote distance with a phone or computer that is connected to the public communication network.

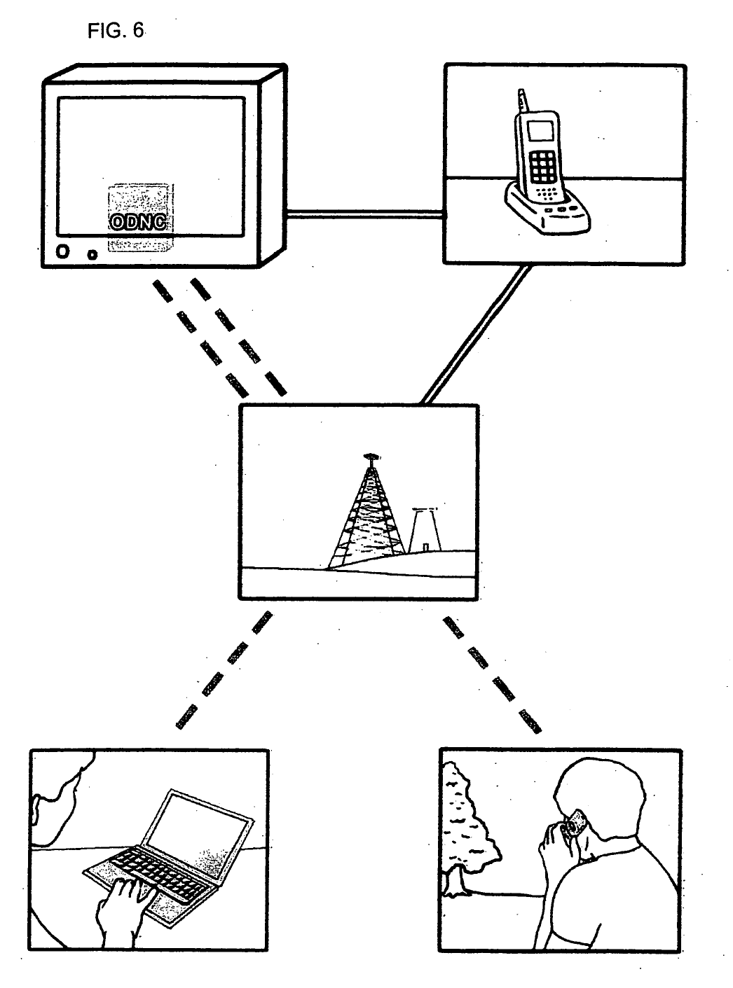

FIG. 6 graphically shows an example of an application of the ODNC 2.

Referring to FIG. 8, the ODNC 2 may communicate with another ODNC 102 to control an electronic device. For example, a robot in which the ODNC 2 is installed may move and approach each appliance to control the appliance by infrared ray or sound wave. This overcomes the distance limit or blocking object problem of the infrared ray or sound wave remote controls of the appliance.

Referring to FIG. 9, the ODNC 104 may be integrated with the other ODNC 106, and the two ODNC's function as a single ODNC 108.

Examples of communication application between electronic appliances that contain ODNC's include a scheme in which one ODNC includes the device control module 9, and another ODNC includes the device control module 9 and the network connection module 10. In another scheme, a robot that has the device control module 9 and the network connection module 10 is controlled remotely, and the robot approaches to another robot or an electronic device that contains an ODNC having the device control module 9 that recognizes commands with a photo sensor or a sound sensor, and control the electronic device directly, and the robot connects to the ODNC of the other robot to transfer the commands and perform the commands. In still another scheme, two remotely controlled robots that have ODNC's with the device control module 9 and the network connection module 10 can send commands and perform commands alternately. When robot I is to control robot II, robot I approaches robot II and becomes integrated with robot II, and the ODNC's of them are connected. Signal is sent to the network connection module 10 of robot II to turn off switch for controlling home page, and robot I directly controls the device control module 9 of robot II.

Application example of ODNC installed in robots include a situation that when a remotely controlled robot B, which works in a location in which wireless internet connection is possible but human access is difficult due to contamination or bacteria, is short of fuel or electric power, or needs other equipments, a remotely controlled robot A approaches robot B and delivers equipments, fills fuel or changes batteries. Depending on circumstances, robot A and robot B are remotely controlled according to contents of software that are included in the ODNC's of the robots via computers connected to the internet or a wireless phone, and the robots send commands or performs commands with each other alternately.

In this way, robots having various different functions can send commands and perform commands with one another via ODNC's, and various electronic devices can be remotely controlled simultaneously.

The present invention may be very useful in civilian's life and business in the following ways. A police robot performs control of remotely controlled robots. A master of a robot C with remotely controlled measurement and camera functions may rent robot D from a mobile robot company, and integrate and use the robots C and D. The robot D has movement and navigation functions. Alternately a master of the robot D may rent the robot C from a mobile robot company.

Numerous applications of the present invention are possible. A user in remote or oversea location, at which wire or wireless communication is available, may observe and protect his house with guard robots, command ventilation or cleaning of the house, protect of facilitate living of living things in the house, and control everyday life such as office work.

In a business adopting ODNC-embedded devices or machines, every customer visiting the business may use her own portable computer or a computer provided in the business building to connect the home page of the business, and remotely pay service fees, to choose, control and receive services by herself. Alternately the owner of the business may provide the remote service by himself. Therefore, it is possible for everyone to run a business with safe guarantee regarding money transaction and personal safety.

The ODNC 2 may be linked to a remote control service of computer network, such as COOLGATE™ or the terminal service. In this case, the ODNC 2 may be equipped with an input connection device, such as a keyboard connection device and a USB port, etc.

The one digital network control system may be used in networking and wire or wireless remote control for electronic appliances, which include security cameras, air conditioners and heaters, lightings, digital TV's, audio systems, interphones, automatic doors, security alarm systems, ventilation devices, robots, machines, and control devices, etc., and are used in homes, offices and factories. The one digital network control system is applicable in various fields including the aerospace industry.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A digital network system comprising:
a) a user communication interface that is adapted to be connected to a public communication network that transfers information between the digital network system and a communication device;
b) a control communication interface that is adapted to exchange information between the digital network system and an electronic device that a user wants to control;
c) a device control module that is adapted to control the electronic device, wherein the device control module comprises a device control software; and
d) a network connection module that comprises a communication software.

2. The digital network control system of claim 1, wherein the public communication network comprises one of the Internet, the public switched telephone network and the mobile communication network.

3. The digital network control system of claim 1, wherein the communication device includes one of a wire telephone, a wireless telephone, a cell phone and a personal computer.

4. The digital network control system of claim 1, wherein the communication software is adapted to be connected to a home page of the electronic device through the internet.

5. The digital network control system of claim 4, wherein the home page displays control functions for the electronic device, wherein the user selects a control function in order to control the electronic device, wherein the home page converts the control function into a number code, and sends the number code to the user communication interface.

6. The digital network control system of claim 5, wherein the number code comprises three to five digits, wherein the home page displays a plurality of screen switches, wherein each of the screen switches comprises one of the number codes.

7. The digital network control system of claim 6, wherein one half of the home page displays the screen switches in a grid, and the other half of the home page displays control functions.

8. The digital network control system of claim 5, wherein the device control module and the network control module communicate with each other according to the number code sent by the home page.

9. The digital network control system of claim 8, further comprising a signal generating device and a signal recognizing device.

10. The digital network control system of claim 9, wherein the signal is in the form of one of sound wave and light, wherein the signal generating device generates a predetermined pattern of sound wave or light according to the number code, wherein the signal recognizing device recognizes the predetermined pattern.

11. The digital network control system of claim 10, wherein the device control software of the device control module operates to send commands to the electronic device.

12. The digital network control system of claim 1, wherein the digital network control system is adapted to be embedded in the electronic device.

13. The digital network control system of claim 1, wherein the control communication interface comprises a infrared ray transmitter, wherein the infrared ray transmitter is operated when the user communication interface receives a command from a user and sends signals to the infrared ray transmitter.

14. The digital network control system of claim 1, wherein the user communication interface comprises one of a wireless LAN and a wireless modem.

15. The digital network control system of claim 1, wherein the digital network control system is operated when a proper user is authenticated through the public communication network.

16. The digital network control system of claim 15, wherein a user is authenticated through the call transfer connection service of the public switched telephone network.

17. The digital network control system of claim 15, wherein the authentication is performed with checking a predetermined telephone number.

18. The digital network control system of claim 1, wherein a user selects a command with a selection system using a telephone, wherein the selection system uses voice or number to recognize input of the user.

19. The digital network control system of claim 18, wherein the selection system provides prerecorded voice menu to the user, wherein the user follows the voice menu to select a desired control function of the electronic device.

20. The digital network control system of claim 19, wherein the user communication interface comprises a telephone receiver, wherein the telephone receiver receives the control function.

21. The digital network control system of claim 20, wherein the telephone receiver recognizes the control function according to predetermined telephone number, wherein the control communication interface comprises a infrared ray transmitter, wherein the infrared ray transmitter is operated when the telephone receiver receives the control function, and sends signals to the infrared ray transmitter according to the control function.

22. The digital network control system of claim 1, wherein the digital network control system communicates with another digital network control system to control an electronic device.

23. The digital network control system of claim 22, wherein the digital network control system is integrated with the other digital network control system, wherein the two integrated digital network control system functions as a single digital network control system.
